(19) United States
(12) Patent Application Publication
(10) Pub. No.: US 2017/0188388 A1
(43) Pub. Date: Jun. 29, 2017

(54) ELECTRONIC APPARATUS AND ELECTROMAGNETIC WAVES CONTROL METHOD

(71) Applicant: KABUSHIKI KAISHA TOSHIBA, Tokyo (JP)

(72) Inventors: Atsushi Nakajima, Tokyo (JP); Kazunobu Konda, Tokyo (JP); Yasuhiro Morioka, Kawasaki Kanagawa (JP); Yoshinobu Fujiwara, Ome Tokyo (JP)

(21) Appl. No.: 15/256,174

(22) Filed: Sep. 2, 2016

(30) Foreign Application Priority Data
Dec. 25, 2015 (JP) 2015-253965

(51) Int. Cl. H04W 74/08; H05B 6/66

(52) U.S. Cl. CPC H04W 74/0816; H05B 6/66; H04W 84/12

(57) ABSTRACT

According to one embodiment, an electronic apparatus includes an electromagnetic wave emitter, a wireless communication circuitry and a hardware processor. The electromagnetic wave emitter emits a first electromagnetic wave. The wireless communication circuitry communicates with another electronic apparatus according to a first standard, using a second electromagnetic wave. The first electromagnetic wave can be noise for a communication by the wireless communication circuitry. The hardware processor determines a period to be allowed to communicate with the another electronic apparatus according to the first standard. The electromagnetic wave emitter emits the first electromagnetic wave during the first period.

### CROSS-REFERENCE TO RELATED APPLICATIONS

This application is based upon and claims the benefit of priority from Japanese Patent Application No. 2015-253965, filed Dec. 25, 2015, the entire contents of which are incorporated herein by reference.

### FIELD

Embodiments described herein relate generally to a technique for controlling electromagnetic waves.

### BACKGROUND

Frequency bands of electromagnetic waves (radio waves) are allocated in accordance with various purposes. For example, a 2.4-GHz frequency band is used for industrial, scientific and medical equipment, and also referred to as an industrial, scientific and medical (ISM) band. The ISM band is expected to be further used for the Internet of Things (IoT), in which any object is connected to a network.

Electromagnetic waves in the 2.4-GHz frequency band are, for example, output by electronic apparatuses such as microwave ovens, and also output by wireless communication devices conforming to a communication standard such as a wireless LAN or the Bluetooth (registered trademark). Therefore, if an electronic apparatus such as a microwave oven is used while a wireless communication device is communicating, the electromagnetic waves output by the microwave oven interfere with the electromagnetic waves for wireless communication.

The communication of the wireless communication device may be interfered with by the interference of the electromagnetic waves.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram for explaining an example of a configuration of a network to which an electronic apparatus (microwave oven) according to an embodiment is connected.

FIG. 2 is an exemplary block diagram showing a system configuration of the electronic apparatus of the embodiment.

FIG. 3 is an exemplary block diagram showing a functional configuration of a control program executed by the electronic apparatus of the embodiment.

FIG. 4 is an exemplary diagram showing a structure of a frame transmitted and received by the electronic apparatus of the embodiment.

FIG. 5 is a diagram for explaining an example in which an electromagnetic wave output time (heating time) of the electronic apparatus of the embodiment is determined so as not to interfere with electromagnetic waves for wireless communication of an external electronic apparatus.

FIG. 6 is a diagram for explaining another example in which the electromagnetic wave output time (heating time) of the electronic apparatus of the embodiment is determined so as not to interfere with electromagnetic waves for the wireless communication of the external electronic apparatus.

FIG. 7 is a flowchart showing a first example of the procedure of a heating control process performed by the electronic apparatus of the embodiment.

FIG. 8 is a diagram for explaining another example of the configuration of the network to which the electronic apparatus of the embodiment is connected.

FIG. 9 is a flowchart showing a second example of the procedure of the heating control process performed by the electronic apparatus of the embodiment.

FIG. 10 is a diagram for explaining another example of the configuration of the network to which the electronic apparatus of the embodiment is connected.

FIG. 11 is a flowchart showing a third example of the procedure of the heating control process performed by the electronic apparatus of the embodiment.

FIG. 12 is a flowchart showing a fourth example of the procedure of the heating control process performed by the electronic apparatus of the embodiment.

FIG. 13 is a diagram showing an example of a confirmation screen image displayed by the electronic apparatus of the embodiment if a heating time is specified.

FIG. 14 is a diagram showing an example of a confirmation screen image displayed by the electronic apparatus of the embodiment if the heating time ends.

FIG. 15 is a diagram showing an example of a confirmation screen image displayed by the electronic apparatus of the embodiment if the temperature of an object after heating is specified.

FIG. 16 is a flowchart showing a fifth example of the procedure of the heating control process performed by the electronic apparatus of the embodiment.

### DETAILED DESCRIPTION

Various embodiments will be described hereinafter with reference to the accompanying drawings.

In general, according to one embodiment, an electronic apparatus includes an electromagnetic wave emitter, wireless communication circuitry and a hardware processor. The electromagnetic wave emitter is configured to emit a first electromagnetic wave including a first frequency band. The wireless communication circuitry is configured to communicate with another electronic apparatus according to a first standard, using a second electromagnetic wave including a second frequency band. The first electromagnetic wave can be noise for a communication by the wireless communication circuitry. The hardware processor is configured to determine a first period to be allowed to communicate with the another electronic apparatus according to the first standard. The electromagnetic wave emitter is further configured to emit the first electromagnetic wave during the first period.

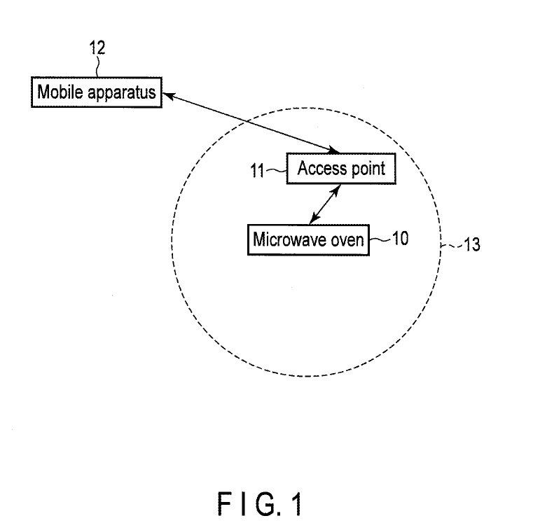

First, a configuration of a communication network to which an electronic apparatus according to one of the embodiments is connected will be described with reference to FIG. 1. The electronic apparatus may be implemented as, for example, an electronic apparatus which outputs electromagnetic waves in a specific frequency band (hereinafter, also referred to as a first frequency band) such as a microwave oven or medical equipment. The first frequency band is, for example, a 2.4-GHz frequency band used for industrial, scientific, and medical equipment, and is the so-called ISM band. It is hereinafter exemplified that the electronic apparatus is implemented as a microwave oven 10.

The microwave oven 10 outputs electromagnetic waves (hereinafter, also referred to as first electromagnetic waves) in the first frequency band to heat an object. Some of the first electromagnetic waves leak out of a housing of the microwave oven 10, and may interfere with other electromagnetic waves. In the example shown in FIG. 1, it is assumed that noise due to the first electromagnetic waves output by the microwave oven 10 is caused in a range 13.

An access point (AP) 11 is an external electronic apparatus which has a wireless communication function and includes a station.

A mobile apparatus 12 is an external electronic apparatus which has a wireless communication function and can operate as a station wirelessly communicating with the access point 11. The mobile apparatus 12 and the access point 11 communicate, using electromagnetic waves (radio waves) in the first frequency band. The mobile apparatus 12 and the access point 11, for example, output electromagnetic waves in the 2.4-GHz frequency band to perform wireless local area network (LAN) communication conforming to the IEEE 802.11b, IEEE 802.11g, or IEEE 802.11n standard. The mobile apparatus 12 and the access point 11 may communicate, using electromagnetic waves (radio waves) in a second frequency band that may be interfered with electromagnetic waves in the first frequency band.

In the wireless LAN communication, the use of radio, which is a communication medium, is controlled by a distributed coordination function (DCF). For the DCF, carrier sense multiple access with collision avoidance (CSMA/CA) is used. In the CSMA/CA, if no electromagnetic wave (carrier wave) transmitting a signal is detected, that is, if there is no other communicating station, a station starts transmission of data (frame) after waiting for a random time (backoff). The other stations connecting with the same access point does not transmit data, if an electromagnetic wave (carrier wave) transmitting a signal is detected. Thus, a collision of frames for data transmission (that is, interference of electromagnetic waves) can be avoided.

In addition, for the DCF, a procedure in which a request-to-send (RTS) frame and a clear-to-send (CTS) frame are exchanged (hereinafter, also referred to as an exchange of RTS and CTS) also can be further used. If no electromagnetic wave (carrier wave) transmitting a signal is detected, a station transmits an RTS frame which requests permission to transmit data after waiting for a random time (backoff). The RTS frame includes a duration field in which a time required to transmit data (frame) is specified. If the station receives a CTS frame which permits data transmission from an access point in response to the transmitted RTS frame, the station can transmit data for the time specified in the duration field. The other stations connecting with the same access point do not transmit data for the time specified in the duration field. Thus, a collision of frames for data transmission (that is, interference of electromagnetic waves) can be avoided by an exchange of RTS and CTS.

In a method using CSMA/CA and an exchange of RTS and CTS, for example, even if electromagnetic waves arrive between an access point and each station but do not arrive between two stations because of a shield, etc., a collision of frames for data transmission can be avoided by the above-described procedure in which an RTS frame and a CTS frame are exchanged.

Incidentally, electromagnetic waves for communication output by the mobile apparatus 12 or the access point 11 and first electromagnetic waves for heating output by the microwave oven 10 are in the same frequency band (2.4-GHz band). Therefore, the interference of these electromagnetic waves makes the communication state between the mobile apparatus 12 and the access point 11 worse, and can cause a decrease in a communication speed, communication incapability, etc.

In addition, some mobile apparatuses and access points are capable of wireless LAN communication conforming to the IEEE 802.11a, IEEE 802.11n, or IEEE 802.11ac standard, which output electromagnetic waves in a 5-GHz frequency band. However, mainly among low-priced apparatuses, a lot of apparatuses are capable of only wireless LAN communication conforming to the IEEE 802.11b, IEEE 802.11g, or IEEE 802.11n standard, which output electromagnetic waves in a 2.4-GHz frequency band.

Therefore, in the present embodiment, the microwave oven 10 is equipped with a wireless communication function, and made to operate as a station wirelessly communicating with the access point 11. That is, the microwave oven 10 and the mobile apparatus 12 both operate as stations connecting with the access point 11. Accordingly, the access point 11, and the microwave oven 10 and the mobile apparatus 12, which wirelessly communicate with the access point 11, constitute a basic service set (BSS).

In addition, in the present embodiment, under a communication procedure of a wireless LAN, a first period (first time) for which the microwave oven 10 outputs first electromagnetic waves for heating is determined by the above-described DCF (CSMA/CA and an exchange of RTS and CTS). More specifically, the microwave oven 10 waits for a third period including a random period, if no electromagnetic wave in the first frequency band (or the second frequency band) which transmits a signal is detected. Then, the microwave oven 10 transmits an RTS frame (RTS packet), if the communication of an external electronic apparatus (the mobile apparatus 12 or the access point 11) and noise are not detected also for the third period. In a duration field of the RTS frame, a time for which a medium (radio wave) is occupied for data transmission transfer (a time required to transmit frames) is set. In the duration field of the transmitted RTS frame, for example, the settable longest time is specified. If the microwave oven 10 receives a CTS frame (CTS packet) from the access point 11 in response to the RTS frame, the microwave oven 10 outputs first electromagnetic waves for heating instead of transmitting data in accordance with the time specified in the duration field. For the time specified in the duration field, the other stations (that is, the mobile apparatus 12 and the access point 11) do not output electromagnetic waves for communication. Thus, the microwave oven 10 can output first electromagnetic waves for heating without interfering with electromagnetic waves for communication output by the mobile apparatus 12 or the access point 11.

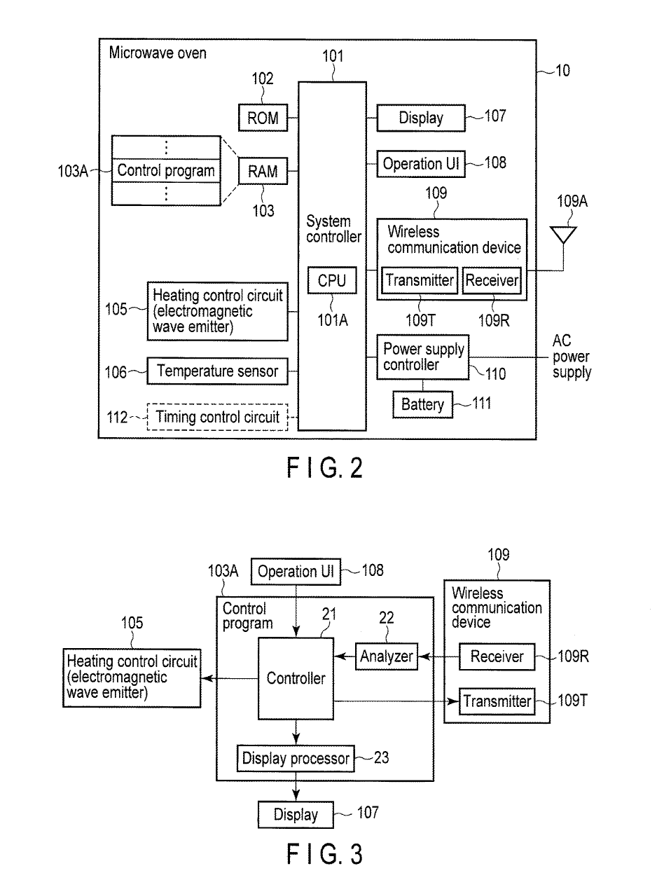

FIG. 2 shows a system configuration of the microwave oven 10.

The microwave oven 10 includes a system controller 101, a ROM 102, a RAM 103, a heating control circuit (electromagnetic wave emitter) 105, a temperature sensor 106, a display 107, an operation user interface (UI) 108, a wireless communication device 109, a power supply controller 110, and a battery 111.

The system controller 101 controls the operation of each component in the microwave oven 10. The system controller 101 includes a CPU 101A, and is connected to the ROM 102, the RAM 103, the heating control circuit 105, the temperature sensor 106, the display 107, the operation UI 108, the wireless communication device 109, and the power supply controller 110.

The CPU 101A is a hardware processor configured to control the operation of components in the microwave oven 10. This processor includes a circuit (processing circuit). In addition, the processor is not limited to one, and processors identical to the processor may be provided. The CPU 101A executes various programs loaded from the ROM 102 into the RAM 103. The programs include a control program 103A.

The control program 103A detects the states of the wireless communication of an external electronic apparatus and noise via the wireless communication device 109, and determines a time for which first electromagnetic waves for heating are output based on the detected states of wireless communication and noise. The control program 103A causes the heating control circuit 105 to output first electromagnetic waves for the determined time.

The function of the control program 103A can be implemented by a circuit such as a hardware processor. Alternatively, this function can also be implemented by a dedicated circuit such as a timing control circuit 112.

The heating control circuit 105 heats an object by emitting first electromagnetic waves in the first frequency band (for example, a 2.4-GHz band). The heating control circuit 105, for example, outputs electromagnetic waves for a specified time. The heating control circuit 105 also can output electromagnetic waves until the temperature of the object to be heated disposed in the housing of the microwave oven 10 reaches a specified temperature, in cooperation with the temperature sensor 106.

The wireless communication device 109 is configured to perform wireless communication conforming to, for example, the IEEE 802.11b, IEEE 802.11g, or IEEE 802.11n standard. The wireless communication device 109 is implemented as, for example, wireless communication circuitry. The wireless communication device 109 is connected to an antenna 109A. The wireless communication device 109 communicates with an external electronic apparatus according to a first standard, using second electromagnetic waves including the first frequency band (for example, a 2.4-GHz band) via the antenna 109A. The wireless communication device 109 may communicate with an external electronic apparatus, using electromagnetic waves including a second frequency band. Note that the first electromagnetic waves including the first frequency band emitted by the heating control circuit 105 can be noise for a communication by the wireless communication device 109 that emits electromagnetic waves including the second frequency band. That is, the first electromagnetic waves including the first frequency band may interfere with the electromagnetic waves including the second frequency band. The wireless communication device 109 includes a transmitter (transmission circuit) 109T configured to wirelessly transmit a signal and a receiver (reception circuit) 109R configured to wirelessly receive a signal. The receiver 109R of the wireless communication device 109 can detect (receive) electromagnetic waves (third electromagnetic waves) for communication in the first frequency band (or the second frequency band) output by the external electronic apparatus and noise.

The system controller 101 contains a memory controller configured to exert access control over the RAM 103 and a display controller configured to control the display 107. The display controller includes a circuit (display control circuit). The display controller receives data for display of the display 107 from the CPU 101A, and generates a display signal output to the display 107, using the data. The display controller transmits the generated display signal to the display 107.

The display 107 displays a screen image based on the display signal.

The operation UI 108 includes, for example, buttons for inputting a user request. In addition, the operation UI 108 may be a touchpanel covering the display 107. The touchpanel functions as a sensor configured to detect a contact position between a screen of the display 107 and an external object.

The power supply controller 110 supplies power to each component in the microwave oven 10, using power supplied from an external AC power supply and/or power supplied from the battery 111. In addition, the power supply controller 110 can also charge the battery 111, using power supplied from the external AC power supply. In other words, the microwave oven 10 is driven by an external power supply such as an AC commercial power supply and/or the battery 111.

FIG. 3 shows a functional configuration of the control program 103A.

The control program 103A includes a controller 21, an analyzer 22, and a display processor 23 as functional modules of the program.

The controller 21 controls the timing with which first electromagnetic waves for heating are output by the heating control circuit 105. The controller 21 determines a first period to be allowed to communicate with an external electronic apparatus (another electronic apparatus) according to the first standard by communicating with the access point 11 via the wireless communication device 109. The controller 21 may determine the first period if the communication of the external electronic apparatus (for example, the mobile apparatus 12) using electromagnetic waves in the first frequency band (or electromagnetic waves in the second frequency band) and noise are not detected, after a request to start heating is input by the user using the operation UI 108. Then, the controller 21 causes the heating control circuit 105 to emit first electromagnetic waves for heating during the determined first period.

More specifically, the controller 21 waits for a certain time after detecting that the other stations are not communicating via the wireless communication device 109, and then waits for a random time. If any station does not start communication during the waiting, the controller 21 determines that the apparatus 10 can communicate. The controller 21 determines (reserves) the first period for which data can be transferred by communicating with the access point 11 via the wireless communication device 109, and designates the first period for which data can be transferred as an electromagnetic wave output time for which first electromagnetic waves for heating are output. The controller 21 causes the heating control circuit 105 to output first electromagnetic waves for heating for the electromagnetic wave output time.

The analyzer 22 analyzes a signal (packet) received via the receiver 109R of the wireless communication device 109. The analyzer 22 detects the presence or absence of the communication of an external electronic apparatus (for example, the mobile apparatus 12 or the access point 11) and noise through the analysis. The analyzer 22 can determine whether the received signal is a packet (frame) for communication or noise.

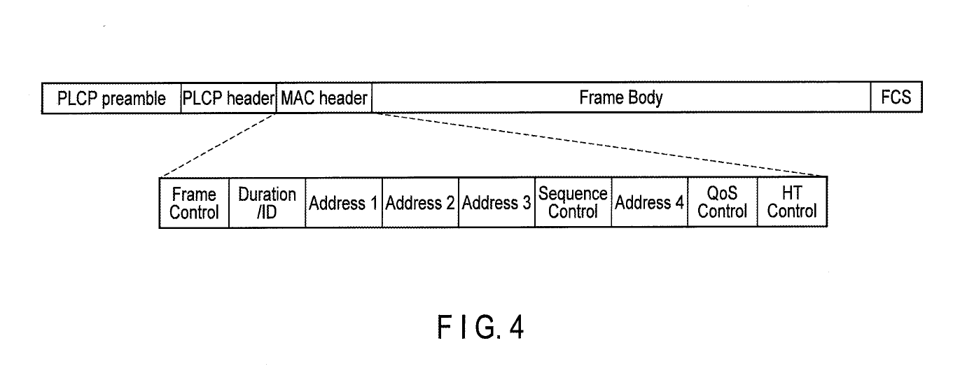

FIG. 4 shows an example of a structure of a packet (frame).

The packet includes fields of a physical layer convergence procedure (PLOP) preamble, a PLOP header, a MAC header, etc. The PLOP preamble field includes a specific bit pattern used as a synchronous signal. The PLOP header field includes information on a modulation technique, a transmission rate, data length, etc. The MAC header field includes fields of frame control, duration/ID, address 1, address 2, address 3, etc. The frame control field includes information on the type of a frame, etc. The duration/ID field includes information on a time for which a medium (radio wave) is occupied for data transfer. The address 1 field, the address 2 field, and the address 3 field each include information on any of a MAC address of a destination, a MAC address of a transmission source, a MAC address (BSSID) of an access point, etc.

Based on this structure of the packet, if the specific bit pattern of the PLOP preamble field is detected from a received signal, the analyzer 22 determines that the signal is a packet for communication. On the other hand, if the specific bit pattern of the PLCP preamble field is not detected from the received signal, the analyzer 22 determines that the signal is noise.

In addition, if the received signal is a packet for communication, the analyzer 22 can also determine whether it is a packet for the apparatus (the microwave oven 10), based on a MAC address of a destination included in an address field of the packet. Moreover, the analyzer 22 can identify a network (BSS) to which a station which transmitted the packet belong based on a BSSID (that is, a MAC address of an access point) included in the packet.

The display processor 23 displays information on the state of heating on the screen of the display 107. The display processor 23 displays information on a heating method, a heating time, a heating temperature, etc., specified by the user, in accordance with input performed using the operation UI 108. In addition, the display processor 23 can also display information on an external electronic apparatus (for example, the mobile apparatus 12 and the access point 11) that is communicating. For example, if the communication of a first external electronic apparatus is detected, the display processor 23 displays information indicative of the first external electronic apparatus that is communicating on the screen. Information on an external electronic apparatus that is communicating includes, for example, a MAC address, an IP address, and a host name. Moreover, the display processor 23 can also display information on the influence of the communication of an external electronic apparatus and noise exerted from when heating is started until the heating ends.

If the user requests the microwave oven 10 to heat an object after the information indicative of the external electronic apparatus that is communicating is displayed on the screen, the controller 21 determines an electromagnetic wave output time (first period) for which first electromagnetic waves for heating are output by the heating control circuit 105 as described above. Then, the controller 21 causes the heating control circuit 105 to output first electromagnetic waves for heating for the determined electromagnetic wave output time.

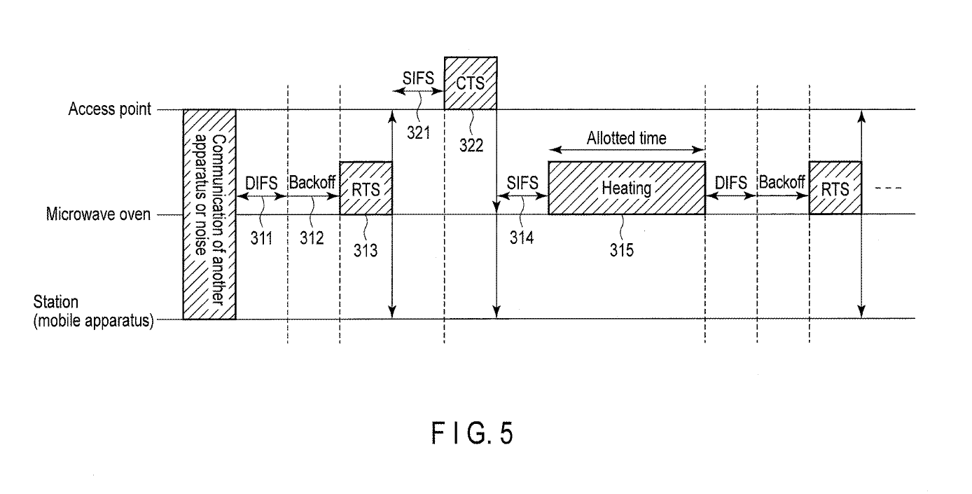

With reference to FIG. 5, an example in which an electromagnetic wave output time (heating time) of the microwave oven 10 is determined so as not to interfere with electromagnetic waves for the wireless communication of the access point 11 and the mobile apparatus (station) 12 will be described.

The analyzer 22 of the microwave oven 10 detects the presence or absence of the communication of an external electronic apparatus and noise, using a signal received via the wireless communication device 109 (the receiver 109R).

If the analyzer 22 detects that there is no communication of the external electronic apparatus and noise, the controller 21 causes the wireless communication device 109 to wait for a DCF interframe space (DIES) 311, and then further wait for a backoff 312. The DIES is a certain time from when it is detected that there is no communication of the external electronic apparatus and noise after a busy state in which electromagnetic waves (radio waves) are used, until it is determined that a switch is made to an idle state in which electromagnetic waves are not used. The backoff is a random time for waiting to transmit a frame to prevent a collision of frames (signals). The controller 21, for example, randomly generates an integer value from 0 to 15, and sets the product of a predetermined value (for example, 3 microseconds) and the generated random value as the backoff. The controller 21, for example, sets 9 microseconds, which is obtained by multiplying 3 microseconds by 3, which is a randomly generated integer value, as the backoff.

If the analyzer 22 detects that there is no communication of the external electronic apparatus and noise also during the waiting for the DIFS 311 and the backoff 312, the controller 21 determines that the apparatus (microwave oven) 10 can communicate. Then, the controller 21 requests the wireless communication device 109 (the transmitter 109T) to transmit an RTS frame (first packet) including a duration field (duration/ID field) in which the settable longest time is specified. For example, in a 15-bit duration field, values from 0 to 32767 microseconds can be set. Accordingly, 32767 microseconds is set in the duration field in which the longest time is specified.

The wireless communication device 109 (the transmitter 109T) transmits an RTS frame 313 in response to the request. In other words, the wireless communication device 109 outputs electromagnetic waves in the first frequency band (or the second frequency band) for transferring the RTS frame 313 via the antenna 109A.

The access point 11 waits for a short interframe space (SIFS) 321 after receiving the RTS frame 313, and then transmits a CTS frame (second packet) 322. That is, the access point 11 outputs electromagnetic waves in the first frequency band (or the second frequency band) for transferring the CTS frame 322. The CTS frame 322 indicates that the microwave oven 10 has a transmission right. In addition, the SIFS is the shortest waiting time in a frame transmission interval, and is, for example, 10 microseconds.

The wireless communication device 109 (the receiver 109R) of the microwave oven 10 receives the CTS frame 322 transmitted by the access point 11 via the antenna 109A. In other words, the wireless communication device 109 receives the electromagnetic waves in the first frequency band (or the second frequency band) for transferring the CTS frame 322 output by the access point 11.

The controller 21 waits for an SIFS 314 after the CTS frame 322 is received by the wireless communication device 109. That is, after the RTS frame 313 is transmitted by the wireless communication device 109, the controller 21 waits for the SIFS 321, waits for a time for transmitting the CTS frame 322, and further waits for the SIFS 314. If the waiting ends, the controller 21 designates an allotted time obtained by excluding the time of the two SIFSs 321 and 314 and the time for transmitting the CTS frame 322 from a time specified in a duration field of the RTS frame 313 as an electromagnetic wave output time (heating time) 315.

As described above, for example, 32767 microseconds is set in the duration field of the RTS frame 313, in which the longest time is specified. The SIFS is, for example, 10 microseconds. In addition, the time for transmitting the CTS frame 322 is, for example, 109 microseconds. In this case, the electromagnetic wave output time (allotted time) 315 is determined as:

$$32767 - 10 - 109 - 10 = 32638 microseconds \approx 33 milliseconds .$$

The controller 21 requests the heating control circuit 105 to output first electromagnetic waves in the first frequency band for heating for the determined electromagnetic wave output time 315.

The heating control circuit 105 heats an object by outputting first electromagnetic waves for heating for the electromagnetic wave output time 315.

To cause the heating control circuit 105 to output first electromagnetic waves for heating for the electromagnetic wave output time 315, the controller 21 may request the heating control circuit 105 to start heating, and request the heating control circuit 105 to stop heating when the electromagnetic wave output time 315 has elapsed. The heating control circuit 105 outputs first electromagnetic waves for heating in response to the controller's 21 request to start heating, and stops first electromagnetic waves for heating in response to the controller's 21 request to stop heating.

After the heating control circuit 105 completes outputting first electromagnetic waves, the controller 21 repeats the above-described procedure until a condition of heating specified by the user is satisfied. The condition of heating is specified by a heating time, the temperature of an object on completion of heating, etc.

In addition, the mobile apparatus 12 waits, if the CTS frame 322 transmitted by the access point 11 is received. If electromagnetic waves (radio waves) for communication output by the wireless communication device 109 of the microwave oven 10 can be received, the mobile apparatus 12 may start waiting when receiving the RTS frame 313 transmitted by the microwave oven 10. The mobile apparatus 12 waits, for example, until the communication of other apparatuses and noise cease to be detected, or until an ACK frame is received from the access point 11.

Through the above, the microwave oven 10 can output first electromagnetic waves for heating without interfering with electromagnetic waves for communication output by the mobile apparatus 12 and the access point 11.

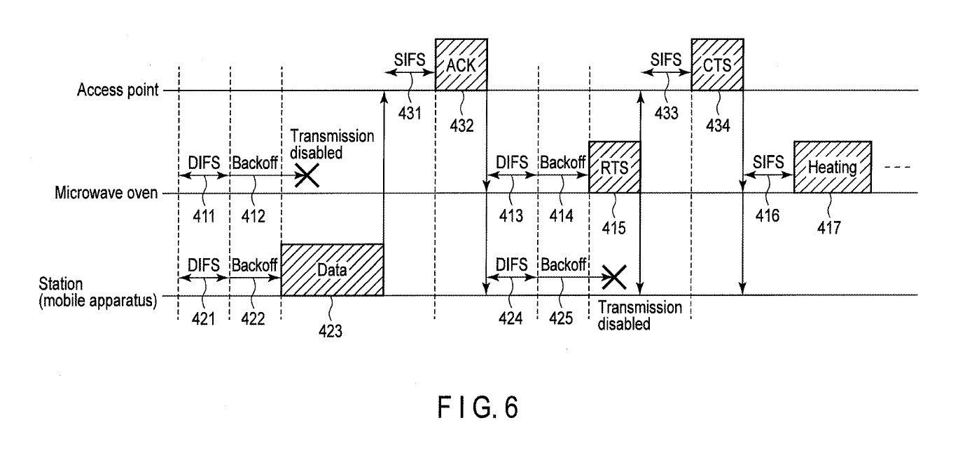

FIG. 6 shows another example in which the electromagnetic wave output time (heating time) of the microwave oven 10 is determined so as not to interfere with electromagnetic waves for the wireless communication of the access point 11 and the mobile apparatus (station) 12. This example illustrates the case where the microwave oven 10 cannot sets the electromagnetic wave output time because the mobile apparatus 12 starts communication while the microwave oven 10 is waiting for a DIFS and a backoff.

The analyzer 22 of the microwave oven 10 detects the presence or absence of the communication of an external electronic apparatus and noise, using a signal received via the wireless communication device 109 (the receiver 109R).

If the analyzer 22 detects that there is no communication of the external electronic apparatus and noise, the controller 21 causes the wireless communication device 109 to wait for a DIFS 411, and then further wait for a backoff 412.

On the other hand, if the mobile apparatus 12 detects that there is no communication of the external electronic apparatus and noise, the mobile apparatus 12 waits for a DIFS 421 and further waits for a backoff 422.

The backoff 422 of the mobile apparatus 12 is shorter than the backoff 412 of the microwave oven 10. Thus, the mobile apparatus 12, which ends the waiting for the backoff earlier than the microwave oven 10, can transmit data 423. It should be noted that the mobile apparatus 12 may transmit an RTS frame after the backoff 422, and transmit the data 423 after receiving a CTS frame transmitted by the access point 11 in response to the RTS frame. The mobile apparatus 12 determines a time (second period) for which data can be transferred via the access point 11 by transmitting the RTS frame, and communicates using electromagnetic waves (third electromagnetic waves) in the first frequency band (or the second frequency band) for the determined time.

Because the communication of the mobile apparatus 12 (that is, the transmission of the data 423) is detected during the waiting for the backoff 412, the controller 21 of the microwave oven 10 cannot transmit an RTS frame. Thus, the controller 21 cannot secure the electromagnetic wave output time for which first electromagnetic waves for heating are output. Therefore, the controller 21 keeps the heating control circuit 105 from outputting first electromagnetic waves for the time (second period) for which the data 423 is transmitted by the mobile apparatus 12.

If the transmission of the data 423 is complete, the access point 11 waits for an SIFS 431, and then transmits an ACK frame 432.

The analyzer 22 of the microwave oven 10 detects the ACK frame 432 from a signal received via the wireless communication device 109. If the ACK frame 432 is received, the controller 21 waits for a DIFS 413, and then further waits for a backoff 414.

In addition, if the ACK frame 432 is received, the mobile apparatus 12 waits for a DIFS 424, and then further waits for a backoff 425.

The backoff 414 of the microwave oven 10 is shorter than the backoff 425 of the mobile apparatus 12. Thus, the microwave oven 10, which ends the waiting for the backoff earlier than the mobile apparatus 12, can transmit an RTS frame 415.

Because the communication of the microwave oven 10 (that is, the transmission of the RTS frame 415) is detected during the waiting for the backoff 425, the mobile apparatus 12 cannot transmit data.

The controller 21 of the microwave oven 10 requests the wireless communication device 109 (the transmitter 109T) to transmit an RTS frame including a duration field in which the settable longest time is specified. The wireless communication device 109 (the transmitter 109T) transmits the RTS frame 415 in response to this request. In other words, the wireless communication device 109 outputs electromagnetic waves in the first frequency band (or the second frequency band) for transferring the RTS frame 415 via the antenna 109A.

The access point 11 waits for an SIFS 433 after receiving the RTS frame 415, and then transmits a CTS frame 434. The access point 11 outputs electromagnetic waves in the first frequency band (or the second frequency band) for transferring the CTS frame 434. The CTS frame 434 indicates that the microwave oven 10 has a transmission right.

The wireless communication device 109 (the receiver 109R) of the microwave oven 10 receives the CTS frame 434 transmitted by the access point 11 via the antenna 109A. In other words, the wireless communication device 109 receives electromagnetic waves in the first frequency band (or the second frequency band) for transferring the CTS frame 435 output by the access point 11.

The controller 21 waits for an SIFS 416 after the CTS frame 434 is received by the wireless communication device 109. In other words, after the RTS frame 415 is transmitted by the wireless communication device 109, the controller 21 waits for the SIFS 433, waits for a time for transmitting the CTS frame 434, and further waits for the SIFS 416. If the waiting end, the controller 21 designates an allotted time obtained by excluding the time of the two SIFSs 433 and 416 and the time for transmitting the CTS frame 434 from a time specified in a duration field of the RTS frame 415 as an electromagnetic wave output time (heating time) 417. The controller 21 requests the heating control circuit 105 to output first electromagnetic waves in the first frequency band for heating for the electromagnetic wave output time 417.

The heating control circuit 105 heats an object by outputting first electromagnetic waves for heating for the electromagnetic wave output time 417.

After the heating control circuit 105 completes outputting first electromagnetic waves, the controller 21 repeats the above-described procedure until a condition of heating specified by the user is satisfied.

In addition, the mobile apparatus 12 waits, if the mobile apparatus 12 receives the CTS frame 434 transmitted by the access point 11. If electromagnetic waves (radio waves) for communication output by the wireless communication device 109 of the microwave oven 10 can be received, the mobile apparatus 12 may start waiting when receiving the RTS frame 415 transmitted by the microwave oven 10. The mobile apparatus 12 waits, for example, until the communication of other apparatuses and the noise cease to be detected, or until an ACK frame is received from the access point 11.

Through the above, the microwave oven 10 can output first electromagnetic waves for heating without interfering with electromagnetic waves for communication output by the mobile apparatus 12 and the access point 11.

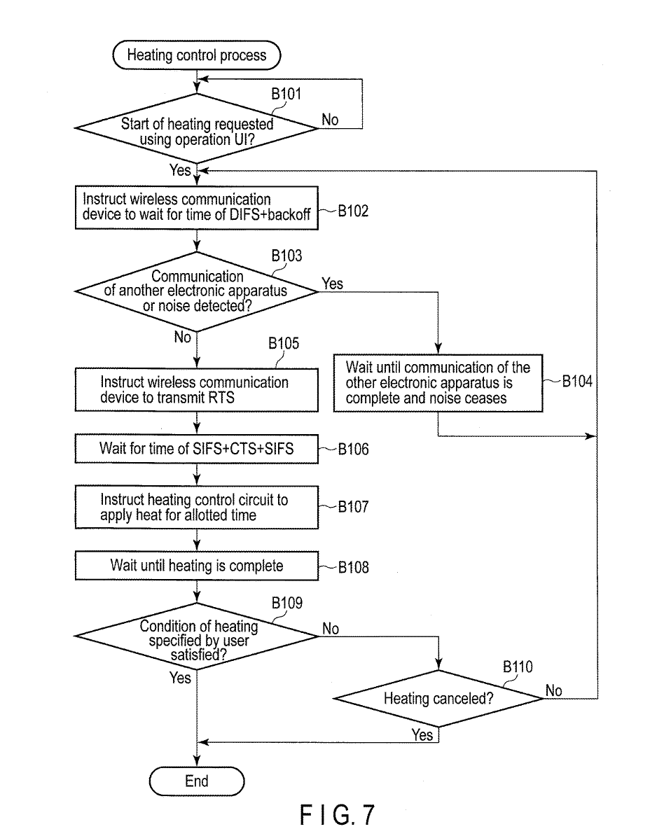

Next, an example of the procedure of a heating control process performed by the microwave oven 10 will be described with reference to the flowchart of FIG. 7.

The CPU 101A determines whether the user has requested the microwave oven 10 to start heating, using the operation user interface (for example, a button or a touchpanel) 108 (block B101). The user requests the microwave oven 10 to start heating by inputting a condition under which a heating time and a heating temperature (the temperature of an object on completion of heating) are specified, and then pressing a “start” button for requesting the microwave oven 10 to start heating, using the operation UI 108. The CPU 101A determines that the user has requested the microwave oven 10 to start heating, for example, if the “start” button for requesting the microwave oven 10 to start heating is pressed. If the user has not requested the microwave oven to start heating (No in block B101), the process returns to block B101, and it is determined again whether the user has requested the microwave oven 10 to start heating.

If the user has requested the microwave oven 10 to start heating (Yes in block B101), the CPU 101A instructs the wireless communication device 109 to wait for a time of a DIFS and a backoff (block B102).

Then, the CPU 101A determines whether the communication of another electronic apparatus (station) or noise has been detected via the wireless communication device 109 (the antenna 109A) during the waiting for the time of the DIFS and the backoff (block B103). If the communication of the other electronic apparatus or noise has been detected (Yes in block B103), the CPU 101A waits until the communication of the other electronic apparatus is complete and the noise ceases (block B104). After the waiting, the CPU 101A returns to block B102, and performs a procedure for starting heating again.

If the communication of the other apparatus and noise have not been detected during the waiting for the time of the DIFS and the backoff (No in block B103), the CPU 101A instructs the transmitter 109T of the wireless communication device 109 to transmit an RTS frame (block B105). The transmitter 109T transmits an RTS frame including a duration field in which the settable longest time is specified. For example, in a 15-bit duration field, values from 0 to 32767 microseconds can be set. Accordingly, 32767 microseconds is set in the duration field in which the longest time is specified.

The CPU 101A waits for an SIFS, a time for CTS transmission, and an SIFS (block B106), and instructs the heating control circuit 105 to apply heat for an allotted time (block B107). The allotted time is, for example, a time obtained by excluding a waiting time (SIFS+CTS+SIFS) after the transmission of the RTS frame from the time specified in the duration field of the RTS frame. The heating control circuit 105 outputs electromagnetic waves for heating for the allotted time. The CPU 101A waits until the heating by the heating control circuit 105 is complete (block B108).

Then, the CPU 101A determines whether the heating by the heating control circuit 105 has satisfied a condition of heating specified by the user (block B109). The CPU 101A determines that the condition of heating specified by the user has been satisfied, for example, if a time that has elapsed since the start of heating was instructed reaches the heating time specified by the user. In addition, the CPU 101A may determine that the condition of heating specified by the user has been satisfied, for example, if the total heating time of the heating control circuit 105 that has elapsed since the start of heating was instructed reaches the heating time specified by the user. Moreover, the CPU 101A, for example, may measure the temperature of an object to be heated with the temperature sensor 106, and determine that the condition of heating specified by the user has been satisfied, if the measured temperature reaches the temperature specified by the user. If the condition of heating specified by the user has been satisfied (Yes in block B109), the process ends.

On the other hand, if the condition of heating specified by the user has not been satisfied (No in block B109), the CPU 101A determines whether the user has requested the microwave oven 10 to cancel heating (block B110). The user requests the microwave oven 10 to cancel heating by, for example, pressing a “cancel” button for requesting the microwave oven 10 to cancel heating in the operation UI 108. If the user has requested the microwave oven 10 to cancel heating (Yes in block B110), the CPU 101A ends the process. If the user has not requested the microwave oven 10 to cancel heating (No in block B110), the process returns to block B102, and a procedure for continuing heating is performed.

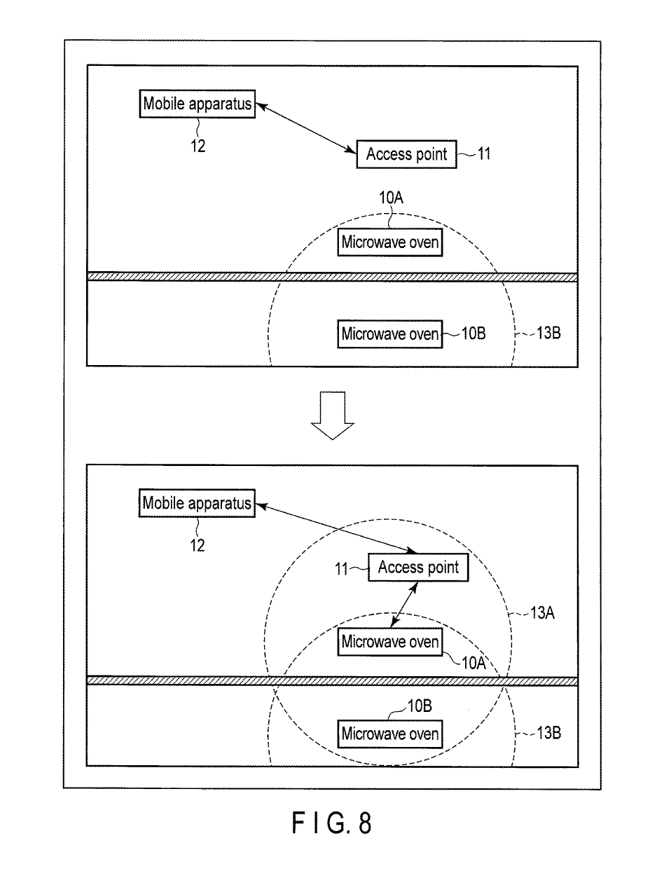

Next, an example in which a microwave oven is influenced by electromagnetic waves output by another microwave oven will be described with reference to FIG. 8. A microwave oven 10A and a microwave oven 10B are installed, for example, in different rooms or different floors. However, the microwave oven 10A is within a range 13B in which noise due to electromagnetic waves output by the microwave oven 10B is produced.

The microwave oven 10A has the same system configuration as the above-described microwave oven 10. While the microwave oven 10B is operating, the microwave oven 10A (that is, the antenna 109A of the wireless communication device 109 [the receiver 109R] provided in the microwave oven 10A) receives (detects) noise due to electromagnetic waves output by the microwave oven 10B.

The microwave oven 10A (that is, the CPU 101A of the microwave oven 10A) determines that the other microwave oven 10B is operating, if noise has been detected for a threshold time or longer. The microwave oven 10A can also start heating, assuming that the other devices (stations) cannot communicate either while the other microwave oven 10B is operating.

However, as shown in the example of FIG. 8, the access point 11 and the mobile apparatus 12 are located outside the range 13B in which the noise of the microwave oven 10B is produced. The access point 11 and the mobile apparatus 12 do not receive the noise of the microwave oven 10B, and thus, the communication between the access point 11 and the mobile apparatus 12 is not influenced by the noise. If the microwave oven 10A starts heating, even though the communication between the access point 11 and the mobile apparatus 12 is not influenced by the noise, there is a possibility that noise due to first electromagnetic waves for heating will be produced in a range 13A and interfere with electromagnetic waves for the communication.

Therefore, in the present embodiment, in order that first electromagnetic waves for heating output by the microwave oven 10A will not interfere with electromagnetic waves for communication, the microwave oven 10A sets a time for which the first electromagnetic waves for heating are output by performing the above-described procedure using CSMA/CA and an exchange of RTS and CTS. For the set time, the other devices (that is, the mobile apparatus 12 and the access point 11) do not output electromagnetic waves for communication. Thus, the microwave oven 10A can output first electromagnetic waves for heating without interfering with electromagnetic waves for the communication between the mobile apparatus 12 and the access point 11.

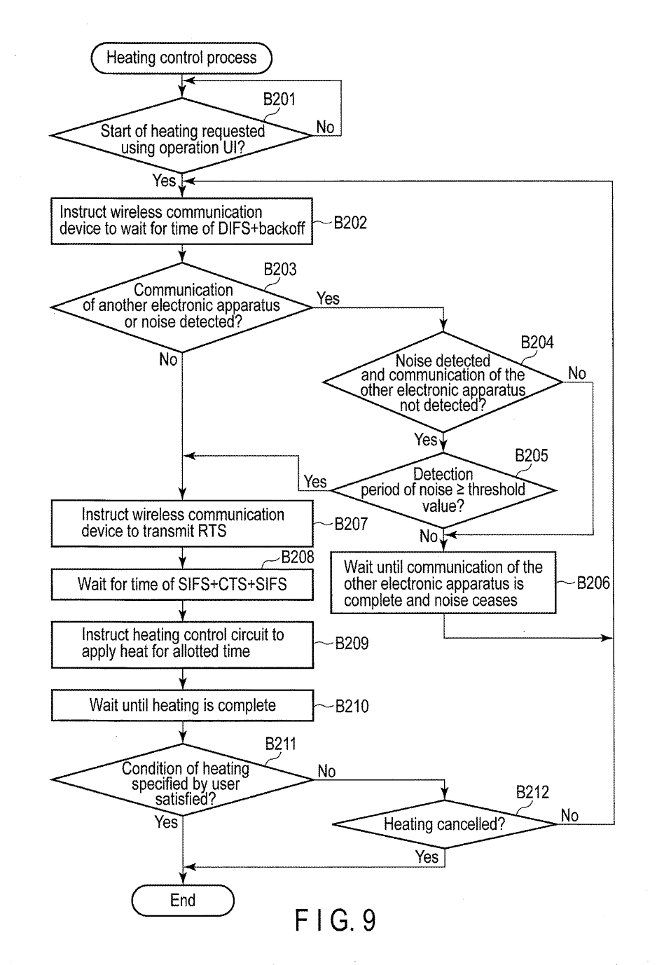

An example of the procedure of the heating control process performed if the microwave oven 10A is influenced by electromagnetic waves output by the other microwave oven 10B will be described with reference to a flowchart of FIG. 9.

The CPU 101A of the microwave oven 10A determines whether the user has requested the microwave oven 10A to start heating, using the operation user interface (for example, a button or a touchpanel) 108 (block B201). If the user has not requested the microwave oven 10A to start heating (No in block B201), the process returns to block B201, and it is determined again whether the user has requested the microwave oven 10A to start heating.

If the user has requested the microwave oven 10 to start heating (Yes in block B201), the CPU 101A instructs the wireless communication device 109 to wait for a time of a DIFS and a backoff (block B202).

Then, the CPU 101A determines whether the communication of another electronic apparatus (station) or noise has been detected via the wireless communication device 109 (the antenna 109A) during the waiting for the time of the DIFS and the backoff (block B203). If the communication of the other electronic apparatus or the noise has been detected during the waiting for the time of the DIFS and the backoff (Yes in block B203), the CPU 101A determines whether the noise has been detected and the communication of the other electronic apparatus has not been detected from a received signal (block B204). Whether detected electromagnetic waves are due to communication or noise can be determined by, for example, whether a preamble of a specific bit pattern is detected from a signal received by the wireless communication device 109. If the specific bit pattern of the preamble is detected from the received signal, the CPU 101A determines that the signal is a packet for communication. On the other hand, if the specific bit pattern of the preamble is not detected from the received signal, the CPU 101A determines that the signal is noise. If the noise has been detected and the communication of the other electronic apparatus has not been detected from the received signal (Yes in block B204), the CPU 101A determines whether a time for which the noise has been detected is greater than or equal to a threshold value (block B205).

If the time for which the noise has been detected is less than the threshold value (No in block B205), the CPU 101A waits until the communication of the other electronic apparatus is complete and the noise ceases (block B206). In addition, if the communication of the other electronic apparatus has been detected (No in block B204), the CPU 101A waits until the communication of the other electronic apparatus is complete and the noise ceases (block 3206). After the waiting in block B206, the CPU 101A returns to block B202, and performs again a procedure for starting heating.

If the time for which the noise has been detected is greater than or equal to the threshold value (Yes in block B205), the CPU 101A instructs the transmitter 109T of the wireless communication device 109 to transmit an RTS frame (block B207). The transmitter 109T transmits an RTS frame including a duration field in which the settable longest time (for example, 32767 microseconds) is specified. If the time for which the noise has been detected is greater than or equal to the threshold value, the noise is produced by the operation of the other microwave oven 10B. Therefore, the CPU 101A determines that the output of first electromagnetic waves by the heating control circuit 105 has no influence. However, as described above with reference to FIG. 8, even if the microwave oven 10A is influenced by the noise of the other microwave oven 10B, the access point 11 and the mobile apparatus 12 may not be influenced by the noise. In such a case, if the microwave oven 10A starts heating, first electromagnetic waves for heating interfere with electromagnetic waves for the communication of the access point 11 and the mobile apparatus 12, and the communication is disabled. Thus, the CPU 101A exchanges RTS and CTS with the access point 11 via the wireless communication device 109.

In addition, even if the communication of the other electronic apparatus and the noise have not been detected during the waiting for the time of the DIFS and the backoff (No in block B203), the CPU 101A instructs the transmitter 109T of the wireless communication device 109 to transmit an RTS frame (block B207).

The CPU 101A waits for an SIFS, a time for CTS transmission, and an SIFS (block B208), and instructs the heating control circuit 105 to apply heat for an allotted time (electromagnetic wave output time) (block B209). The allotted time is, for example, a time obtained by excluding a waiting time (SIFS+CTS+SIFS) after the transmission of the RTS frame from the time specified in the duration field of the RTS frame. There is a possibility that the wireless communication device 109 (the receiver 109R) cannot receive a CTS frame from the access point 11 under the influence of the noise of the other microwave oven 10B. However, the CPU 101A may determine the allotted time, assuming that the CTS frame is received. The heating control circuit 105 outputs electromagnetic waves for heating for the allotted time. The CPU 101A waits until the heating by the heating control circuit 105 is complete (block B210).

Then, the CPU 101A determines whether the heating by the heating control circuit 105 has satisfied a condition of heating specified by the user (block B211). If the condition of heating specified by the user has been satisfied (Yes in block B211), the process ends.

On the other hand, if the condition of heating specified by the user has not been satisfied (No in block B211), the CPU 101A determines whether the user has requested the microwave oven 10A to cancel heating (block B212). The user requests the microwave oven 10A to cancel heating by, for example, pressing the “cancel” button for requesting the microwave oven 10A to cancel heating in the user interface 108. If the user has requested the microwave oven 10A to cancel heating (Yes in block B212), the CPU 101A ends the process. If the user has not requested the microwave oven 10A to cancel heating (No in block B212), the process returns to block B202, and a procedure for continuing heating is performed.

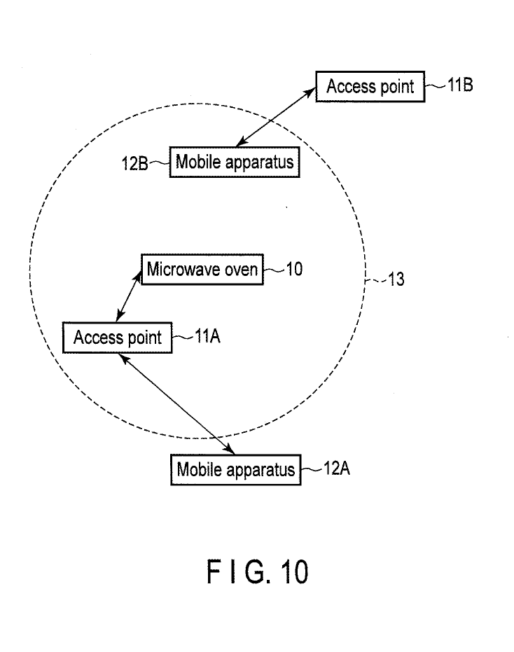

FIG. 10 shows an example in which networks (BSSs) are influenced by electromagnetic waves output by a microwave oven. In the example shown in FIG. 10, it is assumed that noise due to first electromagnetic waves in the first frequency band output by the microwave oven 10 is produced in the range 13.

A first mobile apparatus 12A and a first access point 11A communicate, using electromagnetic waves in the first frequency band (or the second frequency band). In addition, the microwave oven 10 and the first access point 11A communicate, using electromagnetic waves in the first frequency band (or the second frequency band). That is, the first mobile apparatus 12A, the first access point 11A, and the microwave oven 10 constitute a first network (BSS).

Moreover, a second mobile apparatus 12B and a second access point 11B communicate, using electromagnetic waves in the first frequency band (or the second frequency band). That is, the second mobile apparatus 12B and the second access point 11B constitute a second network (BSS).

Electromagnetic waves for communication used in the first network and electromagnetic waves for communication used in the second network may be influenced by the noise of the microwave oven 10 in the range 13.

In the present embodiment, the microwave oven 10 outputs first electromagnetic waves for heating so as not to interfere with electromagnetic waves for communication in the first network, to which the microwave oven 10 belongs. In addition, the microwave oven 10 outputs first electromagnetic waves for heating, even if there are electromagnetic waves for communication in the second network, to which the microwave oven 10 does not belong.

Therefore, the microwave oven 10, for example, determines which of an apparatus (station) in the first network and an apparatus (station) in the second network is communicating, based on a BSSID in a received packet (frame). If it is determined that the apparatus in the second network, to which the microwave oven 10 does not belong, is communicating, the microwave oven 10 treats electromagnetic waves for the communication as, for example, the noise of another microwave oven. That is, the microwave oven 10 determines a time for which first electromagnetic waves for heating are output by performing the above-described procedure using CSMA/CA and an exchange of RTS and CTS, even if the apparatus in the second network is communicating. For the determined time, the other apparatuses (that is, the mobile apparatus 12A and the access point 11A) in the first network do not output electromagnetic waves for communication. Therefore, the microwave oven 10 can output first electromagnetic waves for heating without interfering with electromagnetic waves for the communication of the mobile apparatus 12A and the access point 11A.

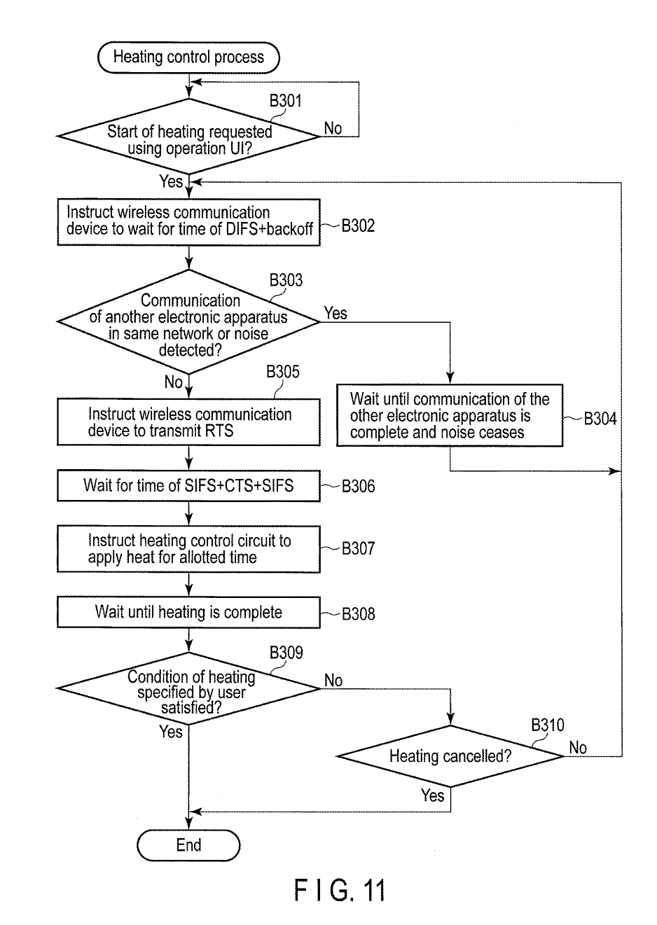

A flowchart of FIG. 11 shows an example of the procedure of the heating control process performed if networks are influenced by electromagnetic waves output by the microwave oven 10.

The CPU 101A determines whether the user has requested the microwave oven 10 to start heating, using the operation user interface (for example, a button or a touchpanel) 108 (block B301). If the user has not requested the microwave oven 10 to start heating (No in block B301), the process returns block B301, and it is determined again whether the user has requested the microwave oven 10 to start heating.

If the user has requested the microwave oven 10 to start heating (Yes in block B301), the CPU 101A instructs the wireless communication device 109 to wait for a time of a DIES and a backoff (block B302).

Then, the CPU 101A determines whether the communication of another electronic apparatus (station) in the same network as the microwave oven 10 or noise has been detected via the wireless communication device 109 (the antenna 109A) during the waiting for the time of the DIFS and the backoff (block B303). The CPU 101A determines whether the other electronic apparatus that is communicating is an apparatus in the same network or an apparatus in another network, based on a BSSID in a received packet. That is, if the BSSID of the BSS to which the microwave oven 10 belongs and the BSSID in the received packet are the same, the CPU 101A determines that the apparatus in the network (BSS) to which the microwave oven 10 belongs is communicating. Alternatively, if the BSSID of the BSS to which the microwave oven 10 belongs and the BSSID in the received packet are different, the CPU 101A determines that the apparatus in the other network is communicating.

If the communication of the other electronic apparatus in the same network or the noise has been detected during the waiting for the time of the DIFS and the backoff (Yes in block B303), the CPU 101A waits until the communication of the other electronic apparatus in the same network is complete and the noise ceases (block B304). After the waiting, the CPU 101A returns to block B302, and performs a procedure for starting heating again.

If the communication of the other electronic apparatus in the same network and the noise have not been detected during the waiting for the time of the DIFS and the backoff (No in block B303), the CPU 101A carries out the procedure of blocks B305 to B310. The CPU 101A can carry out the procedure of blocks B305 to B310, ignoring the communication of the electronic apparatus in the other network, for example, if the communication of the electronic apparatus in the other network has been detected and the noise has not been detected during the waiting for the time of the DIFS and the backoff. The procedure of blocks B305 to B310 are the same as that of blocks B105 to B110 described above with reference to the flowchart of FIG. 7.

It should be noted that the microwave oven 10 also can charge the battery 111 for a waiting time for waiting to start heating, and when the heating is started, output electromagnetic waves for heating, using power supplied from an external AC power supply and power stored in the battery 111. The waiting time for waiting to start heating includes, for example, a time (second period) for which the mobile apparatus 12 connected to the access point 11 can transfer data. By using the stored power, electromagnetic waves for heating can be output with power greater than in the case where only the power supplied from the external AC power supply is used.

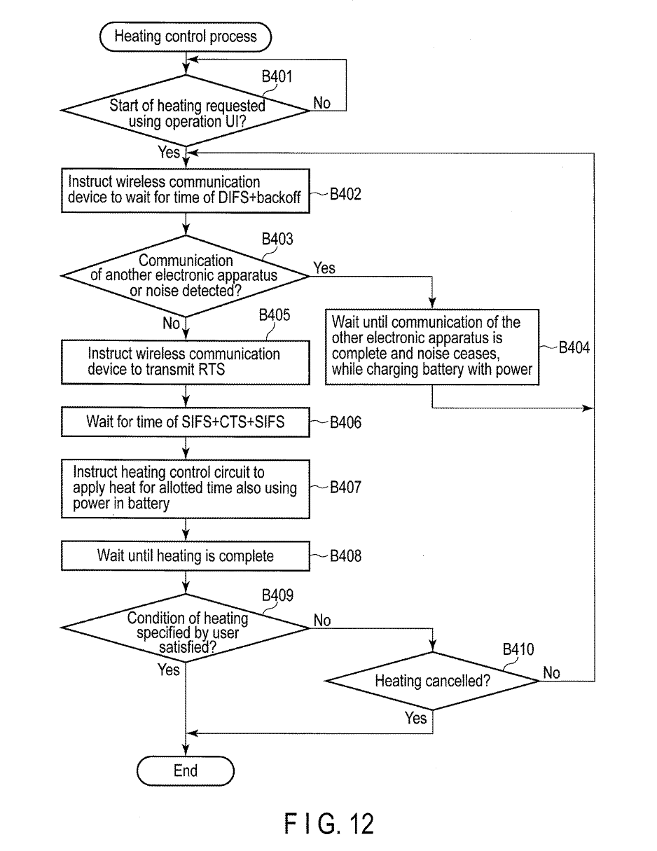

A flowchart of FIG. 12 shows an example of the procedure of the heating control process performed if the stored power in the battery 111 is used.

The CPU 101A determines whether the user has requested the microwave oven 10 to start heating, using the operation user interface (for example, a button or a touchpanel) 108 (block B401). If the user has not requested the microwave oven 10 to start heating (No in block B401), the process returns to block B401, and it is determined again whether the user has requested the microwave oven 10 to start heating.

If the user has requested the microwave oven 10 to start heating (Yes in block B401), the CPU 101A instructs the wireless communication device 109 to wait for a time of a DIFS and a backoff (block B402).

Then, the CPU 101A determines whether the communication of another electronic apparatus (station) or noise has been detected via the wireless communication device 109 (the antenna 109A) during the waiting for the time of the DIFS and the backoff (block B403). If the communication of the other electronic apparatus or the noise has been detected during the waiting for the time of the DIFS and the backoff (Yes in block B403), the CPU 101A waits until the communication of the other electronic apparatus is complete and the noise ceases, while charging the battery 111 with power supplied from the external AC power supply via the power supply controller 110 (block B404). The CPU 101A, for example, waits for a time (second period) for which an external electronic apparatus can transfer data, while charging the battery 111 with power supplied from the external AC power supply. After the waiting (that is, after the second period ends), the CPU 101A returns to block B402, and performs a procedure for starting heating again.

If the communication of the other electronic apparatus and the noise have not been detected during the waiting for the time of the DIFS and the backoff (No in block B403), the CPU 101A instructs the transmitter 109T of the wireless communication device 109 to transmit an RTS frame (block B405). The transmitter 109T transmits an RTS frame including a duration field in which the settable longest time (for example, 32767 microseconds) is specified.

The CPU 101A waits for an SIFS, a time for CTS transmission, and an SIFS (block B406), and instructs the heating control circuit 105 to apply heat for an allotted time, also using power stored in the battery 111 (block B407). The allotted time is, for example, a time obtained by excluding a waiting time (SIFS+CTS+SIFS) after the transmission of the RTS frame from the time specified in the duration field of the RTS frame. If the battery 111 has been charged, the heating control circuit 105 outputs electromagnetic waves for heating for the allotted time, using power (for example, 1000 W) obtained by combining power (for example, 500 W) supplied from the battery 111 and power (for example, 500 W) supplied from the external AC power supply via the power supply controller 110. If the battery 111 has not been charged, the heating control circuit 105 outputs electromagnetic waves for heating for the allotted time, using power (for example, 500 W) supplied from the external AC power supply via the power supply controller 110. The CPU 101A waits until the heating by the heating control circuit 105 is complete (block B408).

Then, the CPU 101A determines whether the heating by the heating control circuit 105 has satisfied a condition of heating specified by the user (block B409). If the condition of heating specified by the user has been satisfied (Yes in block B409), the process ends.

On the other hand, if the condition of heating specified by the user has not been satisfied (No in block B409), the CPU 101A determines whether the user has requested the microwave oven 10 to cancel heating (block B410). If the user has requested the microwave oven 10 to cancel heating (Yes in block B410), the CPU 101A ends the process. If the user has not requested the microwave oven 10 to cancel heating (No in block B410), the process returns to block B402, and a procedure for continuing heating is performed.

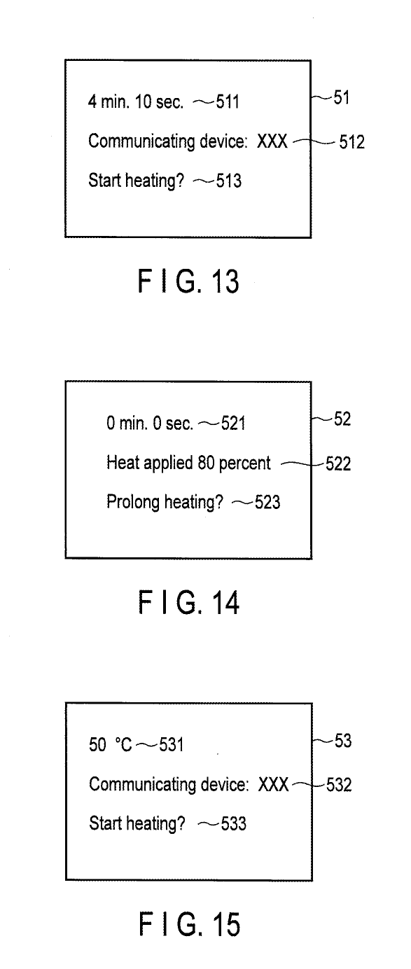

Incidentally, if the communication of an external electronic apparatus is detected, information on the external electronic apparatus that is communicating may be displayed on the display 107 of the microwave oven 10. Examples of screen images displayed on the display 107 of the microwave oven 10 will be described with reference to FIGS. 13 to 15.

FIG. 13 shows an example of a screen image 51 that is displayed if a heating time is specified by the user. The screen image 51 includes a heating time “4 min. 10 sec.” 511 input by the user using the operation UI 108, information 512 indicative of a device (external electronic apparatus) that is communicating, and an inquiry 513 on whether to start heating.

The user determines whether to start heating based on, for example, the information 512 indicative of the device that is communicating. That is, the user determines whether to start heating even if a communication speed declines, or cancel heating to maintain the communication speed. To start heating, the user can request the microwave oven 10 to start heating by, for example, an operation of pressing the “start” button in the operation UI 108.

FIG. 14 shows an example of a screen image 52 that is displayed if a heating time specified by the user has elapsed. The screen image 52 includes a remaining time 521 (here, “0 min. 0 sec.” on completion of heating) of the specified heating time, information 522 indicative of the percentage of a time for which heat was actually applied to the specified heating time (here, “heat applied 80 percent”), and an inquiry 523 on whether to prolong heating. For example, if the specified heating time is 4 minutes and 10 seconds and the time for which heat was actually applied (that is, a time for which first electromagnetic waves were output by the heating control circuit 105) is 3 minutes and 20 seconds, the percentage of the time for which heat was actually applied to the specified heating time is 80 percent.

The user, for example, determines whether to prolong heating based on the information 522 indicative of the percentage of the time for which heat was actually applied. To prolong heating, the user can request the microwave oven 10 to prolong heating by, for example, an operation of pressing the “start” button in the operation UI 108. By this operation, for example, if the percentage of the time for which heat was actually applied to the specified heating time is 80 percent, applying heat for 20 percent of the specified heating time, for which heat was not applied, is requested. The screen image 52 may be displayed while heat is being applied.

FIG. 15 shows an example of a screen image 53 that is displayed if a heating temperature is specified by the user. The screen image 53 includes a heating temperature “50° C.” 531 input by the user using the operation UI 108, information 532 indicative of a device that is communicating, and an inquiry 533 on whether to start heating. The heating temperature indicates the temperature of an object to be heated on completion of heating.

The user determines whether to start heating based on, for example, the information 532 indicative of the device that is communicating. To start heating, the user can request the microwave oven 10 to start heating by, for example, an operation of pressing the “start” button in the operation UI 108.

If there is a device (external electronic apparatus) that is communicating, a time required to reach the specified heating temperature becomes longer than in the case where there is no device that is communicating. This is because, as described above, the heating control circuit 105 is kept from outputting first electromagnetic waves for heating while the external electronic apparatus is communicating.

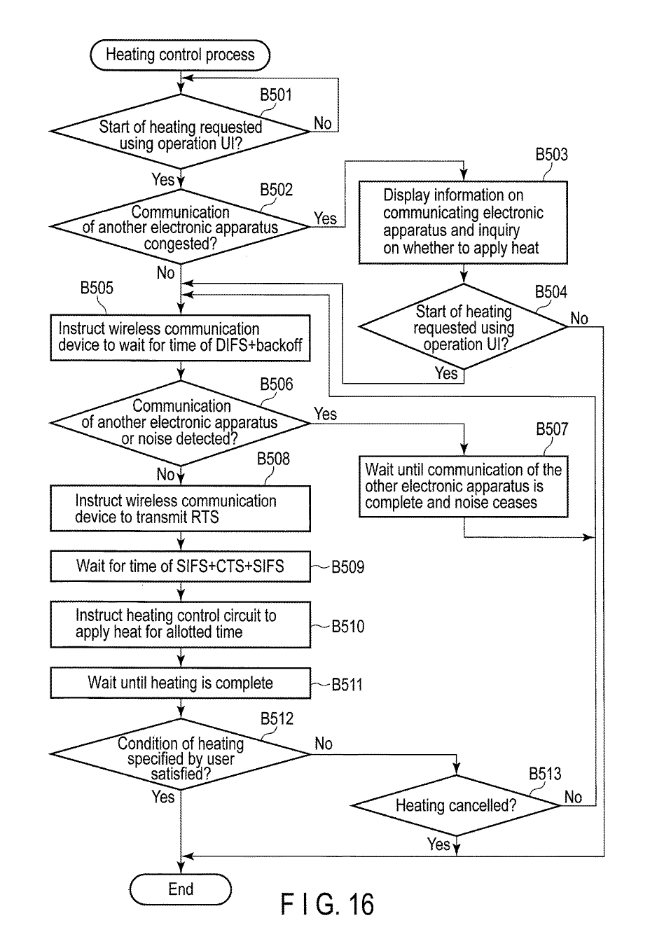

A flowchart of FIG. 16 shows an example of the procedure of the heating control process performed if the wireless communication of an external electronic apparatus (or external electronic apparatuses) is congested. In this heating control process, information on an external electronic apparatus that is communicating is displayed on the screen of the display 107 to ask the user whether to start (continue) heating.

First, the CPU 101A determines whether the user has requested the microwave oven 10 to start heating, using the operation user interface (for example, a button or a touchpanel) 108 (block B501). If the user has not requested the microwave oven 10 to start heating (No in block B501), the process returns to block B501, and it is determined again whether the user has requested the microwave oven 10 to start heating.

If the user has requested the microwave oven 10 to start heating (Yes in block B501), the CPU 101A determines whether the communication of another electronic apparatus (station) is congested via the wireless communication device 109 (the antenna 109A) (block B502). The CPU 101A determines that the communication of the other electronic apparatus is congested, for example, if an electromagnetic wave output time cannot be set for a predetermined time or longer, or if the electromagnetic wave output time cannot be set even though the waiting for a DIFS and a backoff is repeated a predetermined number of times or more.

If the communication of the other electronic apparatus is congested (Yes in block B502), the CPU 101A displays a screen image including information indicative of the electronic apparatus that is communicating and an inquiry on whether to apply heat (block B503). This screen image is, for example, the screen image 51 shown in FIG. 13 or the screen image 53 shown in FIG. 15. The user, for example, checks the information indicative of the electronic apparatus that is communicating on the displayed screen image, and determines whether to apply heat even if the communication of the electronic apparatus is interfered with, or to cancel heating so as not to interfere with the communication of the electronic apparatus. The user requests the microwave oven 10 to start heating or requests the microwave oven 10 to cancel heating, using the operation UI 108.

The CPU 101A determines whether the user has requested the microwave oven 10 to start heating, using the operation UI 108 (block B504). If the user has not requested the microwave oven 10 to start heating (No in block B504), that is, if the user has requested the microwave oven 10 to cancel heating, the process ends.

If the user has requested the microwave oven 10 to start heating (Yes in block B504), or if the communication of the other electronic apparatus is not congested (No in block B502), the CPU 101A instructs the wireless communication device 109 to wait for a time of a DIFS and a backoff (block B505). Then, the CPU 101A determines whether the communication of another electronic apparatus or noise has been detected during the waiting for the time of the DIFS and the backoff (block B506).

If the communication of the other electronic apparatus or the noise has been detected during the waiting for the time of the DIFS and the backoff (Yes in block B506), the CPU 101A waits until the communication of the other electronic apparatus is complete and the noise ceases (block B507). After the waiting, the CPU 101A returns to block B505, and performs a procedure for starting heating again.

If the communication of the other electronic apparatus and the noise have not been detected during the waiting for the time of the DIFS and the backoff (No in block B506), the CPU 101A instructs the transmitter 109T of the wireless communication device 109 to transmit an RTS frame (block B508).

Then, the CPU 101A waits for an SIFS, a time for CTS transmission, and an SIFS (block B509), and instructs the heating control circuit 105 to apply heat for an allotted time (block B510). The allotted time is, for example, a time obtained by excluding a waiting time (SIFS+CTS+SIFS) after the transmission of the RTS frame from the time specified in the duration field of the RTS frame. The heating control circuit 105 outputs electromagnetic waves for heating for the allotted time. The CPU 101A waits until the heating by the heating control circuit 105 is complete (block B511).

Then, the CPU 101A determines whether the heating by the heating control circuit 105 has satisfied a condition of heating specified by the user (block B512). If the condition of heating specified by the user has been satisfied (Yes in block B512), the process ends. It should be noted that if the condition of heating has been satisfied because a specified heating time has elapsed, the CPU 101 may display a screen image (for example, the screen image 52 shown in FIG. 14) including information indicative of the percentage of a time for which heat was actually applied to the specified heating time and an inquiry on whether to prolong heating. Then, if the user has requested the microwave oven 10 to prolong heating by user operation, the CPU 101A returns to block B505, and performs a procedure for continuing heating.

On the other hand, if the condition of heating specified by the user has not been satisfied (No in block B512), the CPU 101A determines whether the user has requested the microwave oven 10 to cancel heating (block B513). If the user has requested the microwave oven 10 to cancel heating (Yes in block B513), the CPU 101A ends the process. If the user has not requested the microwave oven 10 to cancel heating (No in block B513), the CPU 101A returns to block B505, and performs a procedure for continuing heating.

It should be noted that, if there is an external electronic apparatus that is communicating, which of communication and heating is to be given higher priority can also be set in advance. In this case, the CPU 101A performs a process according to the setting without displaying the screen image 51 or the screen image 53 including information indicative of an electronic apparatus that is communicating and an inquiry on whether to apply heat in block B503. In addition, the CPU 101A may display which of communication and heating is to be given higher priority on the screen (for example, display “communication priority mode” or “heating priority mode” on the screen).

As described above, according to the present embodiment, electromagnetic waves can be output so as not to interfere with electromagnetic waves for the wireless communication of an external electronic apparatus. The heating control circuit (electromagnetic wave emitter) 105 emits a first electromagnetic wave including a first frequency band. The wireless communication device 109 communicates with another electronic apparatus according to a first standard, using a second electromagnetic wave including a second frequency band. The first electromagnetic wave can be noise for a communication by the wireless communication device 109. The CPU 101A determines a first period to be allowed to communicate with the another electronic apparatus according to the first standard. The heating control circuit 105 emits the first electromagnetic wave during the first period.

Accordingly, during the first period to be allowed to communicate with the another electronic apparatus, determined according to the first standard, the communication of the another external electronic apparatus according to the first standard is not performed. Thus, the heating control circuit 105 can emit electromagnetic waves so as not to interfere with electromagnetic waves for the wireless communication of the another electronic apparatus. Therefore, for example, even if a microwave oven is used during wireless LAN communication in a 2.4 GHz-frequency band, the wireless LAN communication can be prevented from being completely interfered with.

In the present embodiment, a first period for which data can be transferred is determined by communicating with an access point, and electromagnetic waves are output for the first period. This structure can be applied to not only microwave ovens but also various electronic apparatuses which output electromagnetic waves in the same frequency band as that of electromagnetic waves for communication or output electromagnetic waves that interfere with electromagnetic waves for communication, for example, medical equipment, a Bluetooth communication apparatus, and a cordless telephone.

Various functions disclosed in the embodiment may also be each implemented by a circuit (processing circuit). Examples of the processing circuit include a programmed processor such as a central processing unit (CPU). The processor carries out each of the disclosed functions by executing a computer program (instructions) stored in a memory. The processor may be a microprocessor including an electric circuit. The examples of the processing circuit also include a digital signal processor (DSP), an application-specific integrated circuit (ASIC), a microcontroller, a controller, and other electric circuit components. Components other than the CPU disclosed in the present embodiment may also be each implemented by the processing circuit.

Since various processes of the present embodiment can be implemented by a computer program, the same advantages as those of the present embodiment can easily be obtained simply by installing the computer program in a computer through a computer-readable storage medium in which the computer program is stored and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an electromagnetic wave emitter configured to emit a first electromagnetic wave comprising a first frequency band;
wireless communication circuitry configured to communicate with another electronic apparatus according to a first standard, using a second electromagnetic wave comprising a second frequency band, wherein the first electromagnetic wave can be noise for a communication by the wireless communication circuitry; and
a hardware processor configured to determine a first period to be allowed to communicate with the another electronic apparatus according to the first standard,
wherein the electromagnetic wave emitter is further configured to emit the first electromagnetic wave during the first period.

2. The electronic apparatus of claim 1,
wherein the electromagnetic wave emitter is configured to heat an object by emitting the first electromagnetic wave.

3. The electronic apparatus of claim 2, further comprising a display,
wherein the hardware processor is configured to:
display, if communication of the another electronic apparatus is detected, information indicative of the another electronic apparatus that is communicating on a screen of the display; and
determine the first period if a user performs an operation for heating the object after the information is displayed.

4. The electronic apparatus of claim 1,
wherein the electromagnetic wave emitter is configured not to emit the first electromagnetic wave for a second period for which the another electronic apparatus is allowed to communicate.

5. The electronic apparatus of claim 1,
wherein the hardware processor is further configured to determine the first period if noise is detected and communication of the another electronic apparatus is not detected.

6. The electronic apparatus of claim 1,
wherein the electronic apparatus and the another electronic apparatus is connected to a first access point,
wherein the hardware processor is further configured to determine the first period, if the noise is not detected, communication of the another electronic apparatus is not detected, and communication of still another electronic apparatus is detected,
wherein the still another electronic apparatus is connected to a second access point and being configured to communicate, using a third electromagnetic wave comprising a third frequency band, and the first electromagnetic wave can be noise for the communication by the still another electronic apparatus.

7. The electronic apparatus of claim 1,
wherein the hardware processor is configured to:
charge a battery with power supplied from an external AC power supply for a second period for which the another electronic apparatus is allowed to communicate; and
determine the first period after the second period ends,
wherein the electromagnetic wave emitter is further configured to emit the first electromagnetic wave during the first period, using power supplied from the charged battery and power supplied from the external AC power supply.

8. The electronic apparatus of claim 1, further comprising a display,
wherein the hardware processor is configured to display, if communication of the another electronic apparatus is detected, information indicative of the another electronic apparatus that is communicating on a screen of the display.

9. The electronic apparatus of claim 1,
wherein the hardware processor is configured to:
wait for a third period, if communication of the another electronic apparatus and the noise are not detected;
cause the wireless communication circuitry to transmit a first packet comprising data indicative of the first period, if the communication of the another electronic apparatus and the noise are not detected during the third period; and
determine the first period, if the wireless communication circuitry receives a second packet responding to the first packet from an access point.

10. The electronic apparatus of claim 9,
wherein the third period comprises a randomly determined period.

11. The electronic apparatus of claim 1,
wherein the first frequency band is a 2.4-GHz frequency band.

12. An method performed by an electronic apparatus comprising:
determining a first period to be allowed to communicate with another electronic apparatus according to a first standard by using a wireless communication circuitry in the electronic apparatus, wherein the wireless communication circuitry is configured to communicate with the another electronic apparatus according to the first standard, using a first electromagnetic wave comprising a first frequency band, wherein a second electromagnetic wave comprising a second frequency band emitted by an electromagnetic wave emitter in the electronic apparatus can be noise for a communication by the wireless communication circuitry; and
emitting the second electromagnetic wave during the first period.
